(19) United States
(12) Patent Application Publication
(10) Pub. No.: US 2005/0056213 A1
(43) Pub. Date: Mar. 17, 2005

(54) Defogger line forming device

(76) Inventors: Yasushi Iimori, Aichi-ken (JP); Hiroshi Kuno, Aichi-ken (JP)

Correspondence Address: Morgan & Finnegan, L.L.P., 3 World Financial Center, New York, NY, 10281-2101, US

(21) Appl. No.: 10/917,675

(22) Filed: Aug. 13, 2004

(30) Foreign Application Priority Data
Sep. 11, 2003 (JP) 2003-320203

(51) Int. Cl. C03C 3/066; B05C 3/02

(52) U.S. Cl. 118/410

(57) ABSTRACT

A defogger line forming device is equipped with a nozzle for applying conductive paste to a curved surface resin glass constituting a resin window, a robot arm for moving the nozzle along the window, a contact member provided so as to be movable integrally with the nozzle and adapted to come into contact with the resin window to maintain a fixed distance between the resin window and the nozzle, a volume measurement type supply device for supplying the conductive paste to the nozzle, and a hose communicating with the nozzle and the supply device. More specifically, the nozzle and the contact member are mounted to a bracket at the distal end of the robot arm so as to be slidable in a direction crossing the window, and the supply device is integrally fixed to the bracket.

### BACKGROUND OF THE INVENTION

1. Field of the Invention

The present invention relates to a device for forming the defogger line of a resin window.

2. Related Background Art

Conventionally, when an automobile rear window formed of inorganic glass is to be provided with a defogger line, it has been common practice to impart a conductive paste constituting a heat line to the surface of the inorganic glass in a flat state by so-called screen printing. Thereafter, heat is applied to perform bending into a curved shaped suitable for an automobile rear window, with the paste being dried by heating at approximately 600° C.

Incidentally, as a result of the recent diversification of automobile rear windows, some rear windows are formed not of inorganic glass but of a resin glass (for example, polycarbonate). However, in the case of a resin glass, the window is normally formed from the beginning into a curved shape by injection molding, so that it is impossible to adopt screen printing in imparting the conductive paste as in the case of inorganic glass.

JP 60-23984 A discloses a device (see FIG. 2 of the publication) which is equipped with a nozzle-like applicator, making it possible to impart conductive paste to curved resin glass.

Since the heat-resistant temperature of resin glass is lower than that of inorganic glass, it is necessary to employ a low-temperature baking type conductive paste (of a baking temperature of approximately 120° C.). However, such a low-temperature baking type conductive paste exhibits a high resistance value, so that it has a problem in that the effect of defogger upon energization is rather low. If, in view of this, an attempt is made to achieve an increase in the cross-sectional area of the conductive paste to thereby reduce the resistance value, it becomes rather difficult to make the thickness and width of the conductive paste uniform, thereby making it difficult to achieve a stable resistance state. JP 5-115825 A discloses a device which applies a paste-like material to the flat object while moving it. This device, however, cannot be used when applying a paste-like material to a curved object.

### SUMMARY OF THE INVENTION

The present invention has been made in view of the above problems in the prior art. It is an object of the present invention to provide a defogger line forming device capable of uniformly applying a conductive paste when providing a resin window with a defogger line.

To achieve this objective, a defogger line forming device according to the present invention is characterized by including: a nozzle for applying a conductive paste to a resin window; a mounting portion to which the nozzle is mounted; a transfer mechanism for transferring the mounting portion along the resin window; a contact member provided so as to be movable integrally with the nozzle and adapted to come into contact with the resin window to maintain a fixed distance between the resin window and the nozzle; and a volume measurement type supply means for supplying the conductive paste to the nozzle.

### BRIEF DESCRIPTION OF THE DRAWINGS

In the accompanying drawings:

FIG. 1 is a diagram showing the construction of a defogger line forming device according to an embodiment of the present invention;

FIG. 2 is a diagram showing the construction and operation of an application head of the defogger line forming device of FIG. 1;

FIG. 3 is a diagram showing a modification of the application head of the defogger line forming device;

FIG. 4 is a diagram showing still another modification of the application head of the defogger line forming device, which is different from those of FIGS. 2 and 3; and

FIG. 5 is a diagram showing yet another modification of the application head of the defogger line forming device, which is different from those of FIGS. 2, 3, and 4.

### DESCRIPTION OF THE PREFERRED EMBODIMENT

An embodiment of the present invention will now be described with reference to the accompanying drawings.

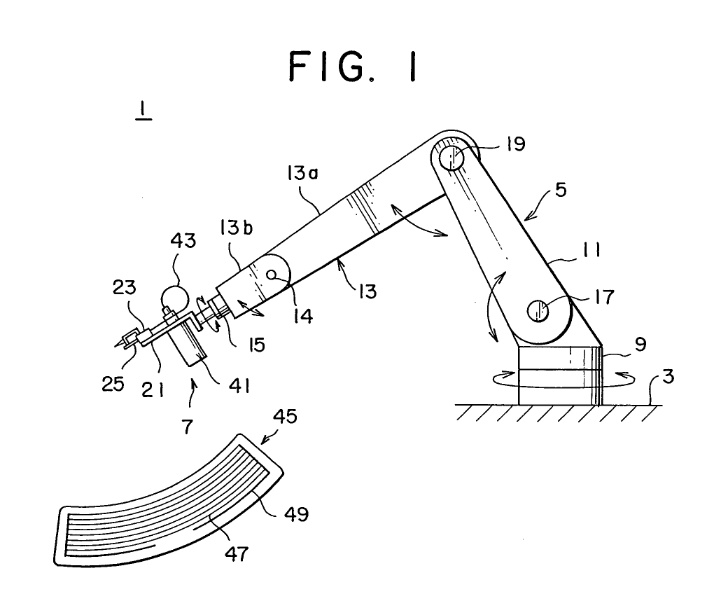

As shown in FIG. 1, a defogger line forming device 1 is equipped with a robot arm (transfer mechanism) 5 secured to an installation surface 3, and an application head 7 mounted to the distal end of the robot arm 5. The robot arm 5 is mainly equipped with a rotation base 9, a first arm 11, a second arm 13, and a rotation end 15. The lower portion of the rotation base 9 is secured to the installation surface 3, and the lower end of the first arm 11 is secured to the upper portion of the rotation base 9. The upper and lower portions of the rotation base 9 are capable of rotating relative to each other, whereby the first arm 11 is rotatably supported by the rotation base 9. Further, the connection between the proximal end of the first arm 11 and the rotation base 9, and the connection between the proximal end of the second arm 13 and the distal end of the first arm 11 are effected by support shafts 17 and 19, respectively, so as to allow relative rotation, whereby the second arm 13 and the first arm 11 are swingable by well-known driving means such as actuators (not shown) with respect to the first arm 11 and the rotation base 9, respectively. Further, the second arm 13 is composed of a main body portion 13a and a distal end portion 13b connected to each other so as to allow relative rotation by a rotation shaft 14, and the distal end portion 13b can change its angle with respect to the main body portion 13a. An application head 7 is mounted to the rotation end 15 provided at the distal end portion 13b, and the rotation end 15 can rotate the application head 7 around the longitudinal axis of the second arm 13 by a well-known drive means, such as a motor.

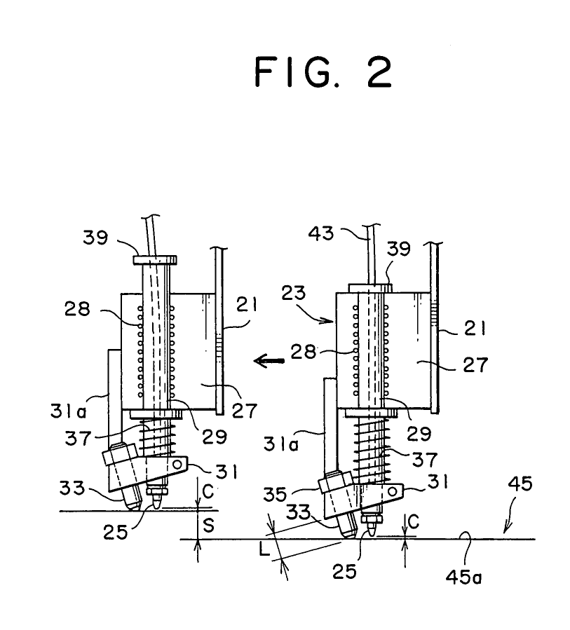

Next, the application head 7 will be described in detail with reference to FIGS. 1 and 2. The application head 7 is equipped with a bracket 21 that has a reverse-L-shaped configuration as seen in FIG. 1. The upper end of the bracket 21 is fixed to the rotation end 15, and a nozzle 25 is mounted to the lower end of the bracket 21 through the intermediation of a slide mechanism 23. The slide mechanism 23 is equipped with a slide cylinder 27 with a rectangular sectional configuration fixed to the bracket 21, and a shaft 29 is slidably inserted into the slide cylinder 27 through the intermediation of ball bearings 28. The nozzle 25 and a slide guide 31 are fixed to the lower end of the shaft 29 so as to be slidable integrally with the shaft 29. A contact member 33 is threadedly engaged with the slide guide 31. The contact member 33 is fixed in position by a nut 35, and the amount L by which the contact member 33 protrudes on the side opposite to the slide cylinder 27 (i.e., downwards as seen in FIG. 2) can be adjusted by loosening the nut 35.

The slide guide 31 is equipped with a guide portion 31a extending substantially parallel to the shaft 29 and in surface contact with the outer surface of the slide cylinder 27. By thus arranging the slide cylinder 27 and the guide portion 31a such that they are in surface contact with each other, inadvertent rotation of the slide guide 31 and thus the contact member 33, etc. is prevented. Further, in the outer periphery of the lower portion of the shaft 29, there is provided a spring 37. The lower end of the spring 37 is in contact with the slide guide 31, and the shaft 29 is constantly pushed downward by the elastic force of the spring 37. Further, at the upper end of the shaft 29, there is formed a stopper head 39. The stopper head 39 is a portion having an outer diameter larger than that of the hole which is formed in the upper surface of the slide cylinder 27 and through which the shaft 29 is passed. By abutting the upper surface of the slide cylinder 27, the stopper head 39 regulates the lowermost position to which the shaft 29 slides.

Fixed to the bracket 21, to which the nozzle 25 is mounted, is a paste pressure-feeding supply device 41 consisting of a volume-measurement-type plunger pump or the like. Further, one end of a hose 43 is connected to the supply device 41, and the other end of the hose 43 is connected to the nozzle 25. That is, the other end of the hose 43 is inserted into the nozzle 25 to communicate with the inlet of the nozzle 25.

Next, the operation of the defogger line forming device of this embodiment, constructed as described above, will be described. Silver paste is used as the conductive paste, and a nozzle with an inner diameter of 0.3 mm is used as the nozzle 25. Further, the protrusion amount of the contact member 33 is adjusted in advance such that a clearance C between an application surface 45a of a curved resin glass 45 and the distal end of the nozzle 25 is 0.1 to 0.7 mm, more preferably, 0.3 mm. Then, the supply device 41 is driven and conductive paste is discharged from the nozzle 25 through the hose 43, and the robot arm 5 is operated to move the application head 7 along the curved surface configuration of the application surface 45a of the curved resin glass 45 (It is to be assumed that the moving direction is perpendicular to the plane of FIG. 2), whereby conductive paste constituting a defogger line 47 is applied to the application surface 45a. More specifically, in this embodiment, the application head 7 is moved by the robot arm 5 at a speed of approximately 200 mm/s to form the defogger line 47 having a thickness of 0.8 mm. Further, during application, the nozzle 25 is controlled by the robot arm 5 such that it is always directed perpendicularly with respect to the application surface 45a of the curved surface resin glass 45 and that a fixed clearance is maintained between it and the application surface. Preferably, the thickness of the defogger line is appropriately selected within a range of 0.6 to 1.0 mm.

Actually, due to the curved surface configuration and minute surface irregularities of the application surface 45a, and the presence of variations in the control of the robot arm 5, etc., there exist factors making it difficult to maintain a desired clearance between the nozzle 25 and the application surface 45a. However, in this embodiment, when the nozzle 25 reaches, for example, a protrusion on the application surface 45a, the spring 37 is deflected, and the contact member 33 is kept in contact with the application surface 45a by the pushing force of the spring 37, with the shaft 29 sliding upwards. Thus, upon reaching a protrusion, the nozzle 25 slides upwards without any fluctuation in the vertical position of the slide cylinder 27, and it is possible to absorb a height S of the protrusion without changing the clearance C between the nozzle 25 and the application surface 45a. Further, after passing over the protrusion, the shaft 29 slides such that the contact member 33 is kept in contact with the application surface 45a by the pushing force of the spring 37, thus continually maintaining the clearance C. That is, in this embodiment, both the nozzle 25 and the contact member 33 can slide integrally, and are constantly pushed towards the application surface 45a by the spring 37, with the approach to the application surface 45a being regulated by the contact member 33, so that, even if there is a factor such as surface irregularities, it is possible to maintain a fixed clearance between the nozzle 25 and the application surface 45a. Further, in this embodiment, the sliding portions of the application head 7 are only the small and light portions, that is, the nozzle 25 and the contact member 33 excluding the supply device 41. Further, the nozzle 25 and the supply device 41 are connected by the hose 43, which is highly flexible, so that, compared with the case in which the supply device is allowed to slide together with the nozzle and the contact member, there is a substantial improvement in terms of the operational conformability of the nozzle 25 with respect to the surface irregularities of the application surface 45a. Thus, it is possible to increase the application speed, thereby achieving an improvement in terms of productivity. Further, in the construction whereby the supply device such as a pump moves together with the nozzle and the contact member, the movable portion of the application head is larger than that of the present invention. Thus, in the case where the curvature of the application surface 45a is large, there is the possibility of the movable portion of the application head interfering with the application surface 45a when moving the application head along the application surface 45a. In this embodiment, however, the portion of the application head 7 in the vicinity of the distal end thereof solely consists of the sliding nozzle 25 and contact member 33, which are compact, whereby it is possible to avoid such interference as mentioned above and to reduce the limitations to a curved window configuration which enables application.

Further, as the supply device 41, not a so-called discharge pressure control type pump but a discharge volume measurement type pump is used, which makes it possible to restrain variation in the discharge amount of the conductive paste under the influence, for example, of the flow resistance in the hose 43, the nozzle 25, etc., the resistance due to the conductive paste existing between the nozzle 25 and the application surface 45a, in addition to the variation in the viscosity of the conductive paste. Further, since the discharge amount of the conductive paste is thus made less subject to the influence of the flow resistance, it is possible to adopt the hose 43 with a small diameter and to arrange the supply device 41 away from the nozzle 25, which is a sliding portion.

As stated above, it is possible to maintain a fixed clearance between the nozzle 25 and the application surface 45a and to attain a fixed discharge amount of the conductive paste, thereby making it possible to apply the conductive paste in the form of a thin, uniform line.

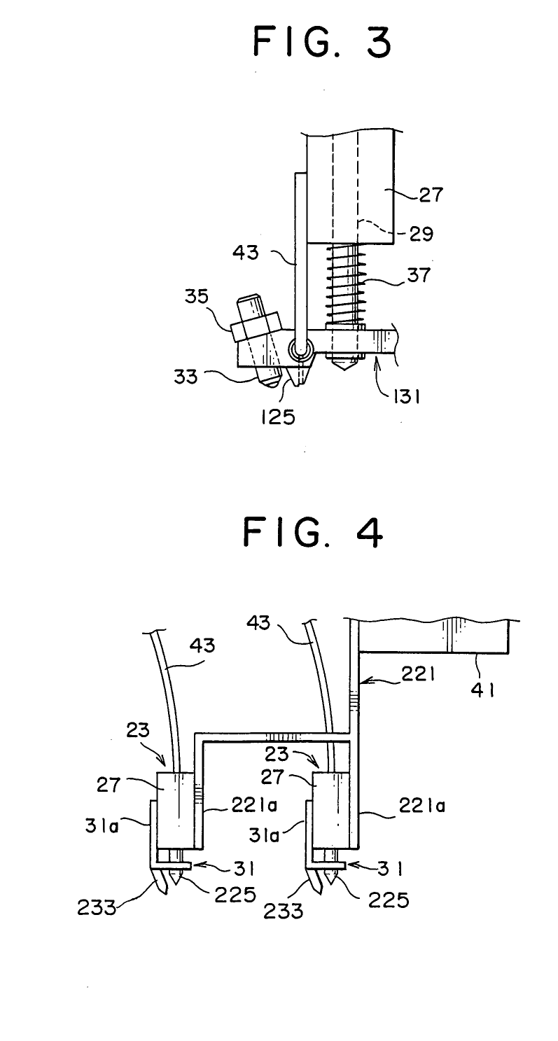

The present invention, described above, is not restricted to the above embodiment but allows various modifications. For example, it is not always necessary for the nozzle to be arranged in the extension of the axis of the shaft. Thus, as shown in FIG. 3, it is also possible to adopt a construction in which the nozzle 125 is fixed not to the shaft 29 but to a slide guide 131.

Further, while in the above-described embodiment the nozzle is caused to slide in a direction perpendicular to the application surface constituting the object of application, this should not be construed restrictively; it is possible for the nozzle to slide in any other direction as long as it crosses the application surface constituting the object of application, that is, in a direction that is not parallel to the application surface. Further, it is not always necessary for the nozzle to slide along its own axis; it is also possible for the nozzle to slide in a direction inclined with respect to its own axis.

Further, while in the above-described example one nozzle is provided for one robot arm 5, it is also possible to provide a plurality of nozzles for one robot arm 5. That is, as in the example schematically shown in FIG. 4 in which two nozzles are provided, there may be prepared a forked bracket 221 having two branch portions 221a, to each of which the nozzle 125, the contact member 133, etc. are mounted through the intermediation of the slide mechanism 23 in a manner similar to that described above. In this modification, conductive paste can be discharged from a plurality of nozzles 125 using a single supply device 41, thereby achieving an improvement in terms of productivity. Further, the conductive paste can be discharged efficiently using a single robot arm 5, which is advantageous from the viewpoint of parts cost and control cost.

Further, regarding the process for applying conductive paste in order to form a power supply portion 49 in the form of a thick line (see FIG. 1) for supplying electric current to each thin defogger line 47, it is possible to adopt a construction in which the paste discharge holes in the nozzle are a plurality of continuously arranged small diameter holes, or slit-like holes, etc. Due to this arrangement, when forming the power supply portion 49, it is possible to apply paste in the form of a thick line with little variation in the application amount and thickness.

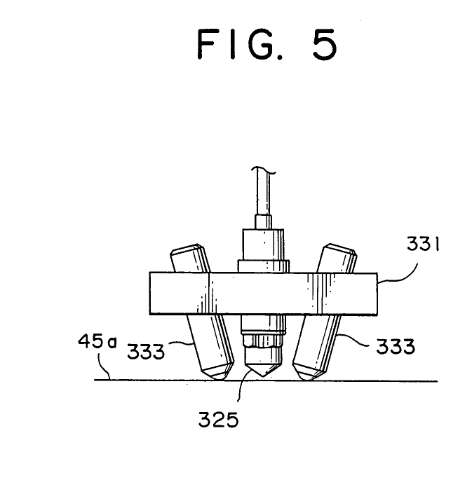

Further, the present invention is not restricted to the arrangement in which only one contact member is provided for one nozzle; it is also possible to adopt an arrangement in which the number of nozzles and the number of contact members are not the same. For example, as schematically shown in FIG. 5, it is also possible to adopt a construction in which one contact member 333 is fixed on either side of one nozzle 325 through the intermediation of a slide guide 331. In this modification, even if the application surface 45a is a complicated, irregular surface, due to the regulation of the approach of the nozzle 325 to the application surface 45a by the two contact members 333, it is possible to maintain a fixed clearance between the nozzle 325 and the application surface 45a without reducing the clearance even when the nozzle 325 is likely to be tilted in more directions.

Further, while in this embodiment the robot arm 5 is used as the transfer mechanism for transferring the nozzle along the resin window, this should not be construed restrictively; it is possible to adopt any other type of transfer control mechanism as long as it allows the nozzle to move along the route in conformity with which the defogger line is to be formed and the movement is possible while maintaining a clearance fixed to some degree with respect to the application surface. Thus, for example, it is possible to prepare a movement control mechanism equipped with two rails allowing the nozzle to move in checkerboard pattern along two orthogonal axes, moving the nozzle in conformity with the route along which the defogger line is to be formed through an appropriate combination of movement amounts in the directions of the two orthogonal axes.

1. A defogger line forming device comprising:
a nozzle for applying a conductive paste to a resin window;
a mounting portion to which the nozzle is mounted;
a transfer mechanism for transferring the mounting portion along the resin window;
a contact member provided so as to be movable integrally with the nozzle and adapted to come into contact with the resin window to maintain a fixed distance between the resin window and the nozzle; and
a supply means for supplying the conductive paste to the nozzle.

2. A defogger line forming device according to claim 1, further comprising a hose communicating with the nozzle and the volume measurement type supply means,
wherein the nozzle and the contact member are mounted to the mounting portion so as to be slidable in a direction crossing the resin window, and
wherein the supply means is fixed to the mounting portion.

3. A defogger line forming device according to claim 1,
wherein the supply means is a volume-measurement-type pump.

4. A defogger line forming device according to claim 1, wherein a plurality of the contact members are disposed oppositely from each other in respect to the axis of the nozzle.

5. A defogger line forming device according to claim 1, wherein the contact member comprises an adjusting mechanism by screws for adjusting the fixed distance to be kept between the resin window and the nozzle.
